(19) United States
(12) Patent Application Publication
(10) Pub. No.: US 2004/0181497 A1
(43) Pub. Date: Sep. 16, 2004

(54) Neural networks

(75) Inventor: Terence Edwin Dodgson, Staines (GB)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/781,017

(22) Filed: Feb. 18, 2004

(30) Foreign Application Priority Data
Feb. 18, 2003 (GB) 0303707.4

(51) Int. Cl. G06N 3/08; G06F 15/18; G05B 13/02; G06G 7/00; G06E 3/00; G06E 1/00

(52) U.S. Cl. 706/23; 706/909

(57) ABSTRACT

A communications system comprising a plurality of terminals each having a neural network therein which has parameter values enabling the network to emulate a transmission processing stage in a transmission mode, and a transmission station for sending new parameter values to the terminals to change the operation of the neural networks to emulate a new transmission mode.

### PRIORITY

This application claims priority to an application entitled “Neural Networks” filed in Great Britain Patent Office on Feb. 18, 2003 and assigned Serial No. 0303707.4, the contents of which are incorporated by reference.

### BACKGROUND OF THE INVENTION

1. Field of Invention

This invention relates to neural networks, and to communication systems which make use of them.

2. Description of Related Art

Neural networks were developed, over the past half century, as a method of computing by attempting to emulate the arrangement of biological neurons. Neural networks therefore, in general, perform processing by combined a number of parallel, simple, calculations. The main use of neural networks is as a learning architecture. In this use, the network is “trained” by applying data to the input of the network.

Neural networks may be implemented as parallel processing hardware (using electronic, opto-electronic, optical, or other computing elements), but are more normally implemented by using one or more conventional computers to perform the calculations of each of the neurons. Thus, whereas the literature discusses “neurons” and calculations in “parallel”, in fact a computer implements these as sequential calculations.

The best known, and most widely used, neural network is the “multi-layer perceptron” (MLP). MLPs are usually trained using the “back-propagation algorithm” developed by Rumelhart et al (D. E. Rumelhart, G. E. Hinton and R. J. Williams, Learning internal representation by error propagation, in: D. E. Rumelhart and J. L. McClelland, Eds., Parallel Distributed Processing:Explorations in the microstructure of cognition, Vol. 1: Foundations, Chapter 8 (MIT Press, 1986)). This method may also be used in embodiments of the present invention.

In a multi-layer perceptron, each node is a feed-forward node, with a number of inputs, a number of weights, a summation point, a non-linear function, and an output port. Each input at an input port is multiplied by the value of the corresponding weight, and the weighted values are summed. In other words, the input vector is multiplied by the weight vector to form a scalar product.

The sum is then feed through a non-linear function (typically a sigmoid function) and passed to the output port. In a multi-layer perceptron, at least two layers are present, so that the output ports of the first layer are connected to the input ports of a second layer.

Neural networks can be trained to recognise patterns, which is their most common application. However, they can also be trained to learn (and therefore replicate) arithmetic or algorithmic functions. In either case, the network is “trained” by applying a pattern of inputs to the inputs of the network, calculating the difference between the outputs at the output nodes of the net and the desired outputs, and using the difference to modify the weight values of the net.

Among the various types of multi-layer perceptron are some which attempt to deal with time-varying or time-dependent signals, including the time-delay neural network (TDNN) described in K. Lang, A. Wabel, and G. Hinton, “A Time Delay Neural Network Architecture For Isolated Work Recognition”, Neural Networks, Vol. 3, pp23-43, 1990, or the networks described in T. Koskela, M. Lehtokangas, J. Saarinen and K. Kaski, “Time Series Prediction with Multi-Layer Perceptron, FIR and Elman Neural Networks” in Proc. World Congress on Neural Networks, pp. 491-496, INNS Press, 1996.

### SUMMARY

In one aspect, the present invention is intended to improve the behaviour of a neural network in progress time dependent data. In this aspect, the present invention provides a data processing device for processing time-varying signals, comprising: input means for receiving a said time-varying signal; computing means for performing a plurality of neuron computations, to provide at least two layers of said neuron computations each comprising at least two parallel said neuron computations, the outputs of one such layer being fed forward to another; each said neuron computation comprising receiving a plurality of input signals, weighting each signal according to a predetermined weight value, and generating an output signal comprising a function of the weighted input signals; and output means for generating at least one output signal from said computing means, the or each output signal comprising a function of the or each input signal; characterised by: cyclical control signals associated with said neuron computations to indicate parts of a time cycle during which some of said neuron computations are inoperative; and time control means for applying said cyclical control signals to said neuron computations during operation of said computing means on said time-varying signals. This makes the neurons capable of operating on time-varying waveforms effectively, whilst not requiring an excessively large network, numerous weights, or long training times.

Preferably, the network further comprises at least one serial to parallel convertor associated with each said neuron computation so as to provide a plurality of parallel inputs to the neuron computation comprising differently-delayed versions of the same signal. This assists in handling time-varying signals.

In this case, preferably it further comprises a gating arrangement associated with each said serial to parallel convertor, said gating arrangement being controllable by a predetermined and updatable control word to specify which of the parallel outputs of the convertor comprise said plurality of parallel inputs to the neuron computation. This enables the number of weights required to be reduced.

In another aspect, the invention is concerned with communication systems. There are, at present, many methods of processing signals in communications systems, including different methods of modulating and demodulating; channel coding and decoding, and compression coding and decoding. One approach which has been discussed is that described as “software radio”. Here, the idea is to provide a receiver or transceiver (with a universal RF or other air interface layer), which can be re-programmed to apply different channel coding and/or compression coding and/or modulation or de-modulation.

One benefit of such a system is that programs can be stored at the receiver or transceiver for multiple different technical standards, so that a given device can be employed in several different communication modes, or can be moved from one jurisdiction to another.

Another possibility is to make the receiver or transceiver capable of receiving new software over the air. Thus, a given device can be updated when a standard changes, or can be re-programmed when it moves to a new jurisdiction. However, the code required to execute a coding or modulation protocol is lengthy and, moreover, must be error protected, further increasing its length. Download times over small bandwidth channels such as mobile telephone channels are therefore long, which is frustrating to the user and costly for the user and/or the network operator.

In another aspect, the invention is therefore intended to reduce the download time required to reconfigure a software radio or other receiver or transceiver device in a communication system. According to a second aspect, the present invention therefore provides a communications system comprising a plurality of terminals each having a neural network therein which has parameter values enabling the network to emulate a transmission processing stage in a transmission mode, and a transmission station for sending new parameter values to the terminals to change the operation of the neural networks to emulate a new transmission mode.

Sending network parameter values requires much less bandwidth than would sending new code to emulate a new protocol, modulation scheme or coding scheme, and hence is cheaper for the network operator and/or user, and quicker and hence more satisfying to the user.

In this aspect, preferably the network used is the same as that of the first aspect.

### BRIEF DESCRIPTION OF THE DRAWINGS

Other aspects, preferred embodiments and features of the present invention, together with advantages thereof, will be apparent from the following description, claims and drawings.

The invention will now be illustrated, by way of example, with reference to the accompanying drawings in which:

FIG. 1 shows the components of a known neural network (also applicable to the present invention) in a training phase;

FIG. 2 shows the components of a known neural network (also applicable to the present invention) in runtime;

FIG. 3 shows the structure of a known multi layer neural network (also applicable to the present invention);

FIG. 4 shows a single neuron making up the neural networks of FIGS. 1-3;

FIG. 5 shows the connection of several single neurons to make up the network in FIG. 3;

FIG. 6 shows the structure of a single neuron according to a first embodiment of the invention;

FIG. 7 is a block diagram illustrating the structure of a known QPSK modulator;

FIG. 8 is a block diagram showing the structure of a neural network according to the first embodiment, consisting of a plurality of neurons as shown in FIG. 6, for emulating the QPSK modulator of FIG. 7;

FIG. 9 shows the structure of a neural network according to a second embodiment of the invention, correspond to that of FIG. 8 but for emulating a different function;

FIG. 10 shows the structure of a neural network, corresponding to that of FIG. 3 but including feedback, for performing demodulation;

FIG. 11a illustrates the process of downloading new functions to a prior art software radio terminal;

FIG. 11b illustrates the corresponding process for a software radio terminal according to a third embodiment of the invention; and

FIG. 12 is a block diagram illustrating the components of the mobile terminal of FIG. 11b.

### DETAILED DESCRIPTION

Operation of Known Neural Networks

In understanding the operation of the embodiments of the invention, it is useful first to describe the operation of a conventional neural network. Such networks operate in two modes, which may be called “training” mode and “running” mode.

Structure of Known Neural Networks

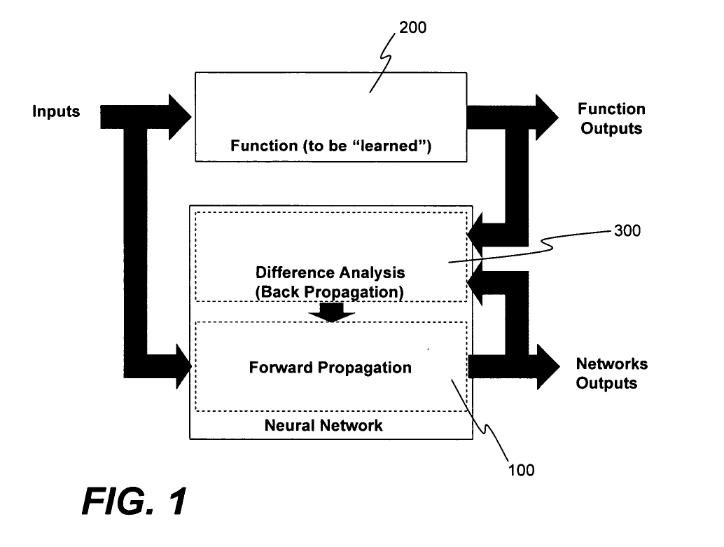

FIG. 1 illustrates the connection of neural network in training mode. The network itself is labelled 100. It receives inputs and generates network outputs. It is implemented as one or more data processing devices (computers or dedicated digital logic chips) capable of performing the calculations described below.

Connected in parallel with the neural network 100 is a processing device 200, which performs a function on the input signals to generate function outputs.

Connected to receive the function outputs and the network outputs is a network training device 300, which trains the network to emulate the function applied by the function device (by attempting to minimise the difference between the function outputs and the respective network outputs).

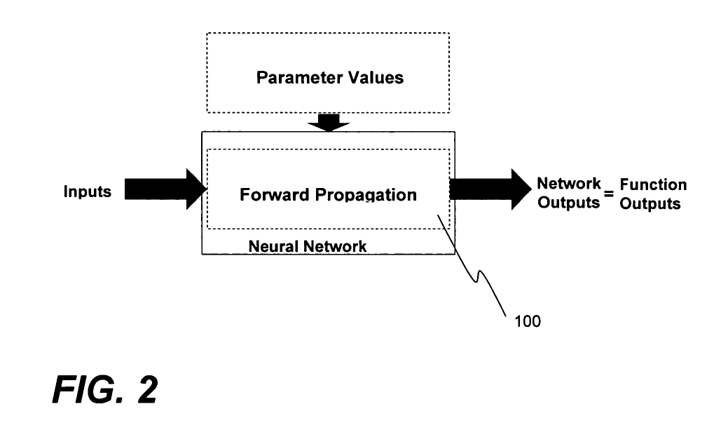

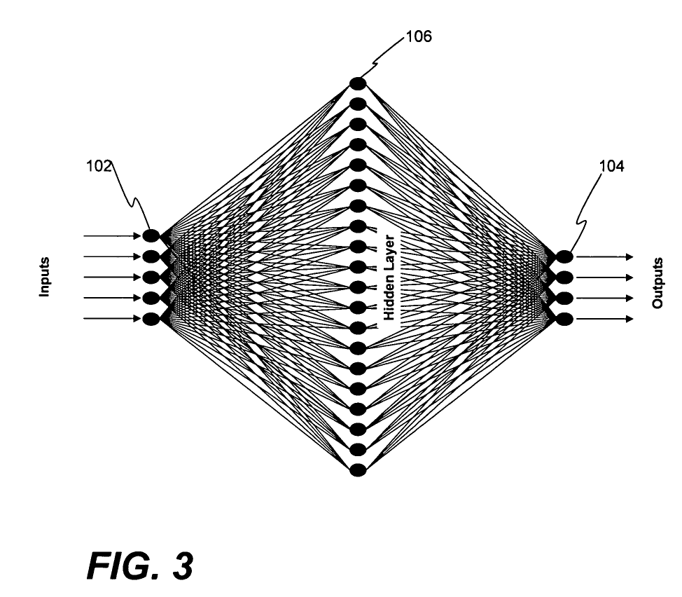

Referring to FIG. 2, in running mode, the neural network 100 receives the input signals and performs an emulation of the function performed by the function device 200 to generate outputs equivalent to the function outputs. Referring to FIG. 3, the neural network 100 consists of a plurality of input nodes 102 each receiving an input signal, and one or more output nodes 104 each generating a network output signal. The input nodes 102a, 102b . . . may be considered to an input “layer” and the output nodes 104a and 104b . . . may be considered to form an output “layer”.

Between the input layer 102 and the output layer 104 is a “hidden layer” 106 comprising a plurality of neuron nodes 106a, 106b . . . The outputs of these nodes are connected to the output nodes 104, and the inputs of each of these nodes is connected to all the input nodes 102, although only a single hidden layer 106 is shown, several may be present, in which case the outputs of each layer are connected to the inputs of the layer which follows and so on.

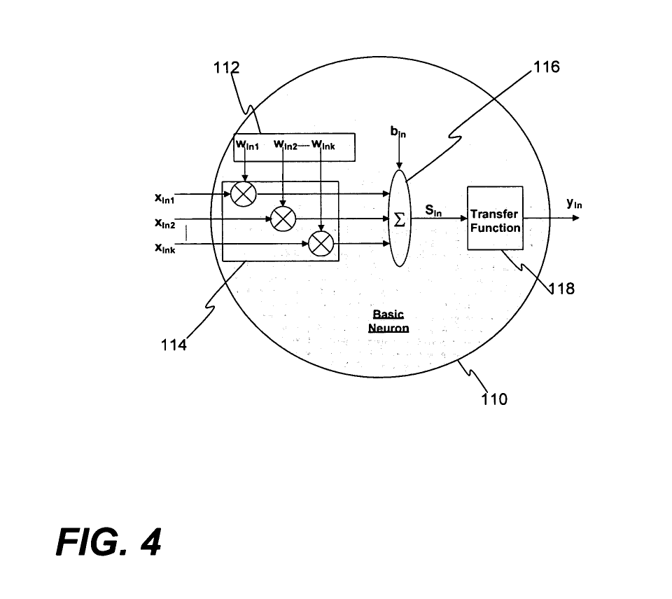

Referring to FIG. 4, each node of the output layer 104 and the hidden layer 106 comprises a neuron 110. The neuron 110 includes a bank of weights 112, each of which is applied to a respective multiplier of a bank of multipliers, 114. The other input port of each multiplier of the bank 114 receives an input signal (either from an input node 102 or a hidden layer node 106). The output ports of the bank of multipliers 114 are connected to a summation node 116, which also receives a constant bias value. The neurons may therefore be seen as lying in an array, defined by a layer index number specifying the layer within which the neuron lies, and a neuron index number specifying it's position within the layer (although for conventional multilayer neural networks this latter has little significance).

The summation node 116 adds the outputs of the multipliers 114 and the bias value to generate a summation signal which is supplied to a transfer function generator 118. The transfer function applies a non-linear function to the output of the summation node 116 to generate the node output signal. It is important that the transfer function is differentiable. The output might then be expressed as:

yₗₙ=Transf(Sₗₙ), where Sₗₙ=bₗₙ+ΣxₗₙₖWₗₙₖ (1)

k

l=network layer number in which neuron n is located

Various transfer functions are known; they are generally monotonic and act to compress the range of the node output signal. A sigmoid function is a widely used example, so that:

Trans(Sₗₙ)=1/(1+exp(−Sₗₙ)) (2)

It is noted that there are many transfer functions that can be applied, though the sigmoid above is chosen as the example in this document. When applying the sigmoid function, as in equation (2) the output value yₗₙ will be in the range 0 to 1.0. The outputs (of any network) should be normalized to meet this requirement.

Training of known Neural Networks

To train the network, the following steps are performed:

1. Initialise weights and bias values;

2. Apply first predetermined input values to the function generator 200 and the neural network;

3. Generate function output values (“target values”) and neural network output values;

4. Measure the differences between the two sets of output values;

5. Modify the weights and bias values in dependence on the difference, to reduce the difference;

6. Repeat steps 1 to 5 with multiple new sets of input values;

7. Test whether differences between the function output values and neural network output values fall below a predetermined threshold for many difference such sets of input values;

8. If not, repeat;

9. If so, the network has converged. Save the weight values and bias values.

One widely used method of this kind is called the Back Propagation algorithm, as disclosed in D. E. Rumelhart, G. E. Hinton and R. J. Williams, Learning internal representation by error propagation, in: D. E. Rumelhart and J. L. McClelland, Eds., Parallel Distributed Processing:Explorations in the microstructure of cognition, Vol. 1: Foundations, Chapter 8 (MIT Press, 1986). This method may also be used in embodiments of the present invention.

Simple Prior Art Example—Training a Single Neuron

To briefly demonstrate a back propagation method, a simple example can be shown, using the model of the prior art basic single neuron shown in FIG. 4. There may be 5 inputs to this neuron, their values being:

xₗₙₖ={−1.05, 0.345, −0.567, 0.3622, −0.3123}, k=1,2,3,4,5

The target value (tₗₙ) the neuron is to output on receipt of this input might be the value,

tₗₙ=0.812345

The neuron must learn suitable weight (wₗₙₖ) and bias (bₗₙ) values, so that this target value is achieved.

Without any prior knowledge, the initial values of wlnk would normally be set to small random values. For example:

wlnk={−0.390808, −0.951294, 0.709839, −0.55365, 0.0999146}, bₗₙ=0.482849

Putting these values into equation (1) and using the sigmoid transfer function given in equation (2) results in an initial neuron output, yₗₙ, of

yₗₙ=0.482704 (as stated earlier the target is tₗₙ=0.812345).

The Difference Analysis device 300 shown in FIG. 1, for a single neuron, would involve trying to alter the neuron weights in an iterative way to converge on the answer (the target) required. A cost function can be derived that is associated with the neuron output and the target value. Such a cost function is shown in equation (3):

δₗₙ=yₗₙ*(1.0−yₗₙ)*(tₗₙ−yₗₙ) (3)

The neuron's bias value would thus be adjusted according to the rule:

b_{ln(new)}=b_{ln(old)}+δₗₙ (4)

The neuron's weights would be adjusted according to the rule:

w_{lnk(new)}=w_{lnk(old)}+δₗₙ*xₗₙₖ (5)

Carrying on the previous example this would give, after the first iteration, the weights and bias value as:

Wₗₙₖ={−0.477235, −0.922896, 0.663168, −0.523837, 0.0742086}, bₗₙ=0.565161

With these new weight and bias values the forward propagation calculations (equations (1) and (2) again) are carried out again. This time the result is:

yₗₙ=0.53965. (closer to tₗₙ=0.812345 than the previous output was).

Carrying on this procedure, after 190 iterations the weights and bias value will be set at:

Wₗₙₖ={−0.972125, −0.76029, 0.395927, −0.353123, −0.0729859}, bₗₙ=1.03648 which will give

yₗₙ=0.812345, with a mean squared error of 8.93621*10⁻¹⁴.

The mean squared error, mse, is between the target value and the output value, i.e.

mse=(tₗₙ−yₗₙ)² (6)

Specifying what the minimum mse should be at the outset would give an end point to the iterative loop processing described, i.e. when the output and target produce an mse less than or equal to that specified at the outset the solution will be deemed to have converged. Naturally, if the mean square error criterion is less strict (i.e. larger in value), the solution would converge quicker but would be less accurate.

The weights and bias value are the parameters that are stored upon convergence. In the running mode the neuron would simply be given these weights and bias values, and would therefore generate roughly the required value of 0.812345 whenever the inputs xₗₙₖ={−1.05, 0.345, −0.567, 0.3622, −0.3123} are applied to it.

Advanced Prior Art Example—Training a Multi-layer Network

FIG. 3 shows a Multi Layer Perceptron (MLP) network, fully connected, having 5 input neurons, 1 hidden layer with 20 neurons, and an output layer having 4 neurons. The input layer consists merely of ports at which the signals are received.

The training/learning of the output neurons can be carried out in the way described previously in this document. However the training/learning of the hidden layer neurons required a slightly different implementation (due to the fact that it is not possible to specify the target values, tln, for any neuron output of a hidden layer—the output for hidden layers are embedded within the Neural Network itself).

Again, different methods could be used to estimate what the target output of a neuron in a hidden layer should be. As an example the target value could be set equal to the current output of that neuron plus the current output multiplied by the sum of all the changes in the weights to which the current neuron's output is attached, i.e.

t_{ln(hidden layer neurons)}=vₗₙ+vₗₙ*Σ₍ₗ₊₁₎n₍ₗ₊₁₎(n+1) (7)

Here ^{ΔW}(l+1)n₍ₗ₊₁₎(n+1) denotes the (already calculated) change in all weights of layer (l+1) of all neurons in layer (l+1) whose weight numbers are (n+1) and l,n are the layer number and neuron number of the current neuron.

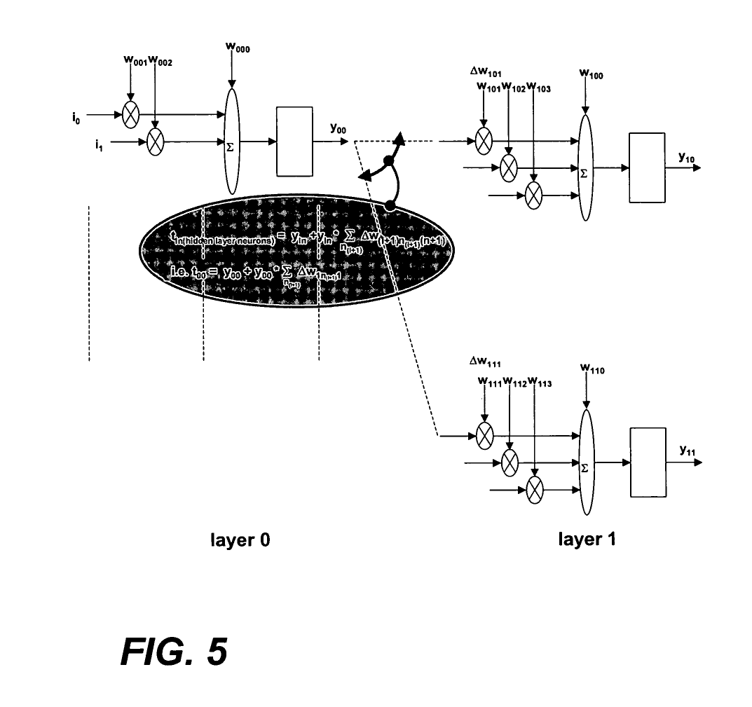

With this additional piece of information, captured in equation. (7), a Neural Network of the type shown in FIG. 5 can be subject to the same processing as that described for the Basic Neuron. For Forward Propagation this would involve working from input nodes 102, performing normalization procedures for each neuron of the input layer before moving onto the first hidden layer. The process is also illustrated in FIG. 5.

At the hidden layer 106 the forward calculations are undertaken for that layer, again working down the layer from neuron 0 to the last neuron in that layer, before moving onto the next layer. The forward calculations will stop when the calculations for the last neuron of the output layer 104 have been performed.

To complete the first iteration, Back Propagation then commences, this time starting with the output layer, calculating all weight changes for each neuron in the output layer before going back to the penultimate layer (the last hidden layer of the network).

The procedure carries on, determining weight changes for all layers in this backwards fashion until all neurons of the first hidden layer (usually referred to as layer 0) have had their weights changed. The first iteration through the network is thus complete and the next set of inputs can be presented to the input of the neural network to begin the next iteration.

Again the procedure carries on until the required conversion (determined through measurement of the mean square error, for example, between all target values and all output values) has been achieved.

First Embodiment—QPSK emulation

In the case of some functions, the function output at a given moment depends not only on the inputs at that moment, but also on previous inputs or outputs. A neural network as described above is unable to model such functions.

In this embodiment, each neuron of a neural net is an extended neuron 120 comprising a basic neuron 110 as described above, together with one or more serial in parallel out (SIPO) buffers 122a, 122b. Each input port of the extended neuron 120 is supplied to one of the input ports of the basic neuron 110. It is also supplied to one of the SIPO registers 122.

The SIPO registers 122 each have an additional output line at each delay stage. The additional output lines are also coupled to input ports of the basic neuron 110. Thus, the basic neuron 110 possess many more input ports than the extended neuron 120, some of which are coupled to time delayed versions of the signals appearing at the input ports of the extended neuron 120.

Each SIPO register also comprises a gate circuit, so that the corresponding delay stage output of the SIPO register can either be passed, or blocked (in which case, zero value is output from that delay stage). The SIPO registers 122 have a control port which receives a switching control word, comprising a bit for each of the delay stage outputs, indicating whether the gate for that output should be open or closed. Thus, for example, each SIPO register may comprise 128 delay stages. If only the 16^{th} and 32^{nd} bits of the switching control word are set, then only the 16 delay stage output and the 32^{nd} delay stage output will be coupled to the inputs of the basic neuron 110 from the SIPO 122. The control word therefore determines the lengths of delays applied to an input signal.

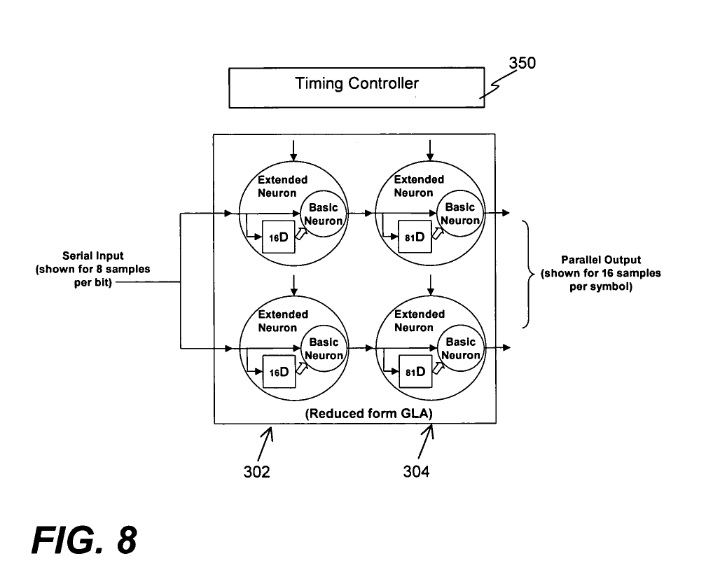

Finally, the extended neuron 120 has a control port for receiving a timing control waveform from a timing controller (shown as 350 in FIG. 8). The control waveform determines whether the extended neuron 120 generates an output. It is a cyclical binary waveform, with a first state in which the neuron is active and a second state in which the neuron output is gated off.

It will be clear that with a zero value switching control word for each SIPO register 122, and with the control waveform in the enabled state, the extended neuron 120 adds nothing or the operation of the basic neuron 110 within it, and a network of extended neurons would act like a conventional MLP. However, use of the gating control words and the control waveforms enables a neural network to take account of time depends in the input signal.

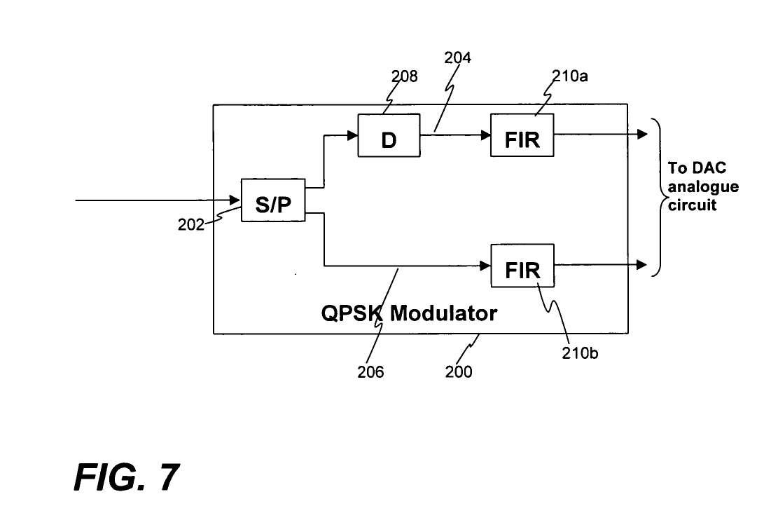

FIG. 7 shows the structure of a differential quadrature phase shift keying (QPSK) modulator. It comprises a serial to parallel converter 202, which distributes bits alternately between a first path 204 and a second path 206. The bits on the first path 204 are delayed by a delay stage 208 to produce a differential output. The two bit streams 204, 206 are then filtered by a respective finite impulse response (FIR) filters 210a, 210b, and the filtered outputs are supplied to two quadrature inputs of the analogue half of the modulator circuit. To train a neural network to emulate the QPSK modulator, however, the filtered signals are used as the function output signals.

FIG. 8 shows a neural network suitable to be trained to emulate the QPSK modulator 200. It has two layers of neurons according to the invention (termed “extended neurons” herein). The first layer 302 receives the serial input bit stream. The outputs of each neuron 302a, 302b of the first layer 302 form the inputs of each neuron 304a, 304b of the second layer 304. The outputs of each neuron of the second layer 304 make up a parallel output matching that of the QPSK modulator of FIG. 7.

The input data arrives at a rate of 8 samples per bit, and is bitwise switched alternately onto two branches, so that the output data is generated at a rate of 16 samples per symbol (one symbol is generated for each two bits arriving in the QPSK modulator).

The Network in Training Mode

First, the timing waveform is selected. In this case, since each of the two branches (302a, 304a; 302b, 304b) is only active half the time (since alternate bits are routed down it) the timing waveform for the upper two neurons 302a, 304a is ON for the first 8 samples and OFF for samples 9-16, then ON again for samples 17-24 and so on. The timing waveform for the lower two neurons 302b, 304bis OFF for the first 8 samples and ON for samples 9-16, then OFF again for samples 17-24 and so on. In other words, the waveforms operate on a cycle of 16 samples and alternate with each other.

Then, suitable values of the gating control words are selected. The neurons of the first layer are given a 16 delay long value (i.e. delay stages 1 to 16 are switched on, and the others are off) so as to cover the whole length of one symbol, and the delay lines on the second layer neuron are given an 81 delay long value (i.e. delay stages 1 to 81 are switched on, and the others are off) so as to include sufficiently long delays to implement a Finite Impulse Response (FIR) filter with a reasonably long impulse response.

Then, the neural net is trained in exactly the same way as a conventional neural network described above—however, only those weights which are connected to delay stages which are gated ON are trained, and the neurons are only trained whilst their timing waveforms are ON. Thus, due to the alternation of the timing waveforms, neurons from one branch do not generate outputs which feed to neurons in the other branch.

The Network in Running Mode

In run time operation, the network has a timing controller circuit 350, which is driven from the system clock (not shown) in synchronism with the sample rate. The timing controller circuit 350 is connected to each of the neurons. It stores the timing control waveforms for each neuron and supplies them to the neurons so as to gate the neuron outputs off and on cyclically, in accordance with the timing waveform. Each neuron uses the stored weights which were derived in training, and the delay values set by the gating control words.

It has been shown that the neural network of this embodiment can be trained to give exactly the same response as the QPSK modulator, and that the weight values of the second stage neurons after training closely resemble the weight or tap values designed for the FIR filters 210a, 210b of the QPSK modulator. As opposed to a conventional neural network, the complexity of the network required, and the time to train it, are both vastly reduced by the use of the timing waveform (to prevent the neurons trying to train when in fact they need not do so) and the gating control words (to limit the maximum length of delay required and hence the numbers of weights per neuron).

Second Embodiment—Channel Coding and Modulation

Another example of a use of the present invention is in emulating a conventional codec comprising a channel coder (i.e. applying error correcting coding) followed by zero bit stuffing and filtering, forming the digital part of a modulation process. Zero bit stuffing is a processing of inserting a zero after a string of successive 1 value data bits, to prevent them being interpreted as control characters.

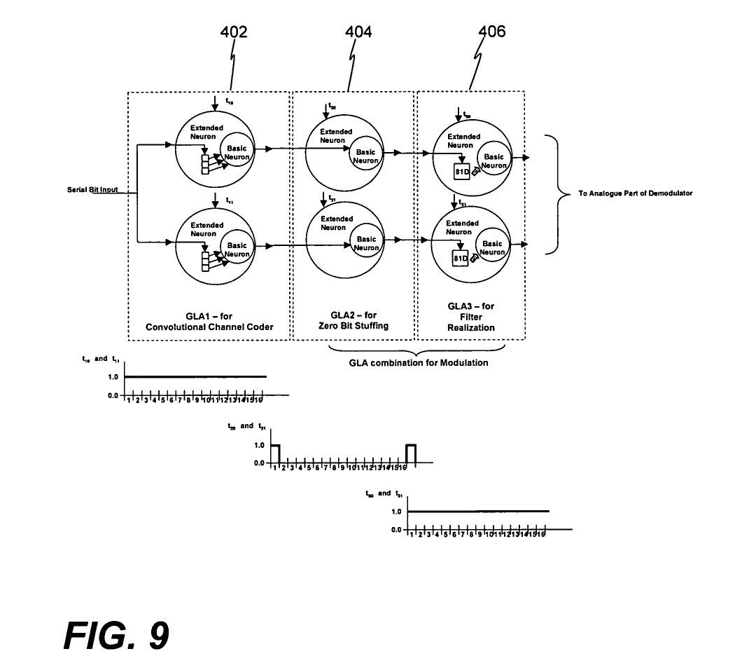

FIG. 9 shows the neural network structure which may be employed to emulate such an arrangement. It comprises a first layer 402, the neurons of which receive as input the serial bit stream carrying the data to be encoded; a second layer 404 the neurons of which receive as their inputs the outputs of those of the layer 402; and an output layer 406, the inputs of which receive the outputs of the middle layer 404, and the outputs of which are supplied to the analogue part of the modulator circuit.

The Network in Training Mode

The timing control waveforms for the first layer 402 and the output layer 406 are initially set to keep the neurons of those layers ON at all times. The timing control signals for the intermediate layer 404 are, as shown in FIG. 9, set so that the neurons are only ON every 16^{th} sample, so as to pass only a narrow slice of each bit on to the next layer for filtering.

The neurons of the input layer are set to enable the first 17 delay stages. They are then trained to emulate the convolutional channel coder, using back propagation.

In the intermediate layer neurons 404, the control words for the SIPO registers are set to zero, so that no delayed signal outputs are processed. The neurons of the intermediate layer 404 are then trained to perform bit stuffing, using the one-in-sixteen timing cycle to control the neurons. The output delay lines are set to 81 delay stages in the output layer neurons 406, and the neurons of the output layer 406 are trained to perform filtering.

The Network in Running Mode

In run-time, as in the preceding embodiment, the network has a timing controller circuit 350, which is driven from the system clock (not shown) in synchronism with the sample rate. The timing controller circuit 350 is connected to each of the neurons. It stores the timing control waveforms for each neuron and supplies them to the neurons so as to gate the neuron outputs cyclically OFF and ON, in accordance with the timing waveform. Each neuron uses the stored weights, which were derived in training, and the delay values set by the gating control words.

It is found that the neural network can be trained to emulate the digital part of the channel coding and modulation scheme of the coder. In further tests, it was found that the input layer neurons could be trained to emulate both channel coding and source coding (i.e. compression coding) in a single training operation.

Third Embodiment—Emulation of Demodulation

The preceding example shows that the neural networks of the present embodiments can perform coding. This is essentially a feed-forward process.

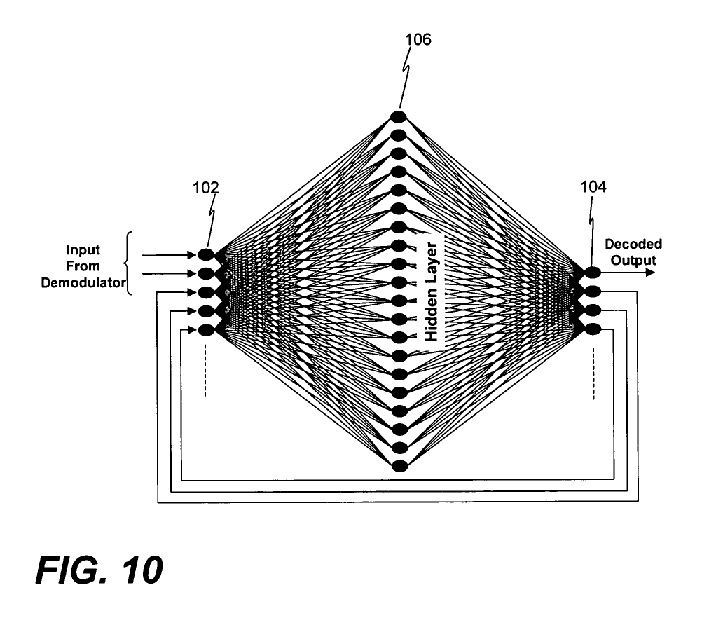

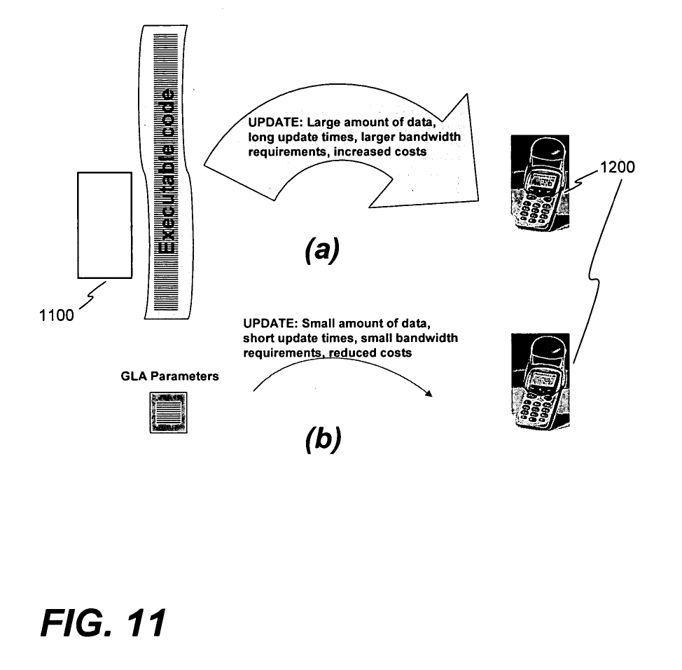

By contrast, decoding of convolutional codes requires memory of previous data. In a further embodiment of the invention, this can be provided by adding feedback paths from certain neuron output nodes to some of the inputs of the neural network, as shown in FIG. 10. The structure of FIG. 10 can be trained by using a Viterbi decoder as the function generator 200, and can emulate the performance of the Viterbi decoder when trained. Further detail of this arrangement is disclosed in our co-pending UK application number ______, having agents reference J00045187GB. Other aspects of modulation and demodulation processes for which the invention is suitable are disclosed in our co-pending UK application number 0219740.8, having agents reference J00044623GB.

Summary of Preceding Embodiments

These embodiments will therefore be seen to provide a neural network with time control waveforms to switch parts of the network on and other parts off at a given time. This assists the network to learn the processing of time dependent signals. Where the function to be emulated possess several parallel paths which are alternately processed, such as a QPSK modulator as described above, knowledge of the structure of the coder can be used to set up the time control waveforms so that at any given moment, only part of the network is trained. Thus, different parts of the network can be trained to emulate the different branches of the coder, resulting in swifter training time since there is no time wasted in attempting to adapt relevant weights.

The provision of serial to parallel converters (shift registers) on the neuron inputs makes it easier for the network to train on time-varying data. The use of a control word to set the taps or delay stages from which outputs will be supplied is an additional advantage, since, again, advance knowledge of the general structure of the function to be emulated (for example, advance knowledge of the typical codec delays, or the delays in different paths) can be used to ensure the number of weights to be adapted is limited only to those which are necessary, thus reducing the training time and the number of weights required in the network.

Whilst it is preferred that the gating control words contain at least one bit per delay stage, so as to be able to specify exactly which taps are turned on, in simpler variants, it is sufficient merely to specify the maximum length of the shift register (i.e. the last tap which is turned on).

A neural network can be provided which can be adapted to emulating many different functions performed on time dependent signals, by making all neurons in multiple layers generic, so that they all possess the serial to parallel registers and time control waveform ports discussed above.

Fourth Embodiment—Software Radio

One particularly preferred application of the present invention is in “software radio” and particularly mobile communications (for example mobile telephony) using software radio.

Accordingly, this embodiment comprises two separate neural networks: a first neural network which operates only in training mode, and a second neural network which operates only in runtime mode. The first neural network is provided at a central location 1100, which may be that of a network provider or a provider of network content. It consists of a computer such as a Sun workstation, running a program to emulate the neural network 100, the function to be learned 200, and the network training device 300.

Within a mobile terminal 1200 such as a mobile telephone, a second neural network is located. The second neural network operates only in runtime, as in FIG. 2, and does not include the difference analysis device 300. However, it does include the timing controller 350 shown in FIG. 8.

In operation, as will be described in greater detail below, when a new method of coding or other data processing is developed, the first neural network is trained (as described in the above embodiments) to emulate the new method of coding, and a set of parameter values is derived. The parameter values comprise the following:

Data specifying the neurons to be programmed;

A set of weight values for each of those neurons;

A gating control word for each of the shift registers for each of the neurons; and

A timing control waveform associated with each neuron.

This set of parameter values is then supplied to the mobile terminal. Initially, when the mobile terminal is manufactured, at least one set of parameter values is stored so that the terminal can communicate using at least one coding and/or modulation method. Later, additional parameter values can be transmitted to the mobile terminal, to add or change the data processing it uses to communicate.

If the coding and filtering arrangement shown in FIG. 9 is to be implemented in the mobile terminal 1200, then the network station 1100 (containing a computer implementing the first neural network, and coding and radio transmission equipment) is provided with the coder and modulator 200 to be emulated. Signal data is then supplied to the inputs of the coder 200 and the neural network 100, and the neural network is trained. The training process does not need to take place in “real-time”; the coder can be run at a substantially lower bit rate. When the neural network has been trained so that its outputs match those of the coder and modulator to be emulated, over a wide range of training data, the weights which were derived in training are taken, together with the timing control waveforms and the gating control words, to form the parameter value set to be transmitted to the mobile terminal 1200.

Next, the parameter value set is encoded for transmission. The encoding can reduce redundancy present in the parameter value set, and also protects the data against transmission errors.

For example, many neurons will share the same timing control waveform. Rather than transmitting a separate timing control waveform for each neuron, data is sent which identifies the group of neurons to which the waveform relates. For example, where (as here) the neurons are arranged in a rectangular array, the data may specify the lower left hand corner and upper right hand corner of the group of neurons which share the timing control waveform.

To represent the timing control waveform, the length of the cycle (in sample periods) is first specified. The waveform within each cycle may be redundancy-encoded; for example, in many cases, the waveform stays in the same state for a continuous run of values, so run-length coding (RLC) may be used to encode the timing control waveform.

In relation to the gating control words, where certain lengths of SIPO register may commonly be used, variable length coding may be used to efficiently encode the control words. Also, where all the neurons of the layer or other group of neurons may share the same gating control word values, as with the timing control waveform, the value may be transmitted only once, together with data which indicates the group of neurons to which it applies (for example, in the form of the upper left hand and bottom right hand co-ordinates of the neurons concerned).

Error correction coding is applied to protect some of the parameter values to a greater extent than others; for example, to protect the timing control waveforms and gating control words to a greater extent than the weight values, and to protect the higher order bits of the weight values to a greater extent than the lower order bits.

Having encoded the data, it has been found that the volume of data to be transmitted is small compared to the volume which would be required to transmit code to implement the function concerned. The encoded parameter values set is then transmitted to the mobile terminal 1200.

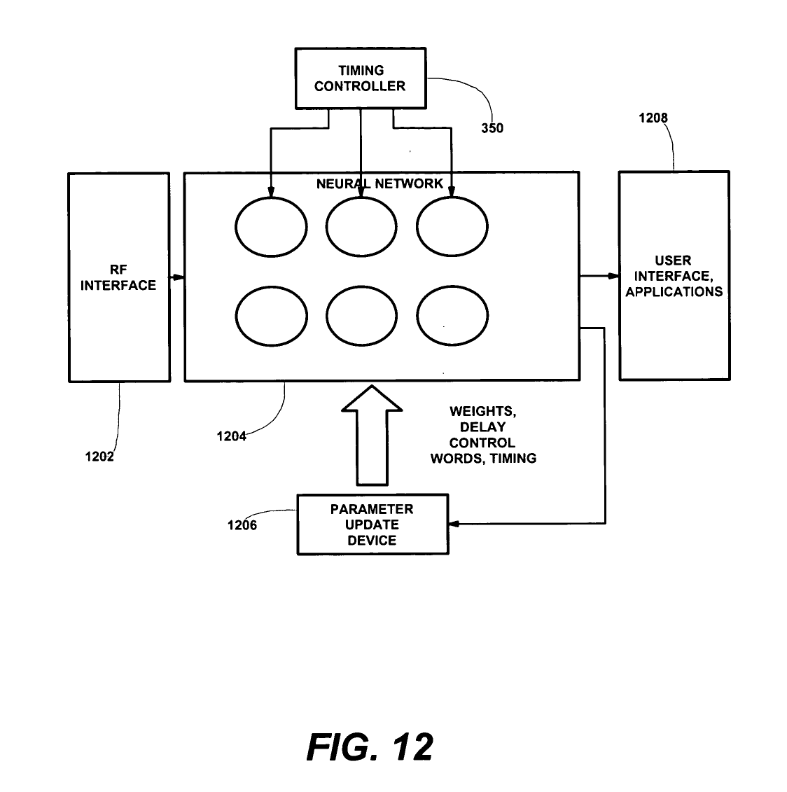

Referring to FIG. 12, the mobile terminal 1200 of this embodiment comprises a radio circuit 1202 comprising analogue components for demodulating a radio signal in a specified air interface format and supplying it to an analogue to digital converter, which outputs digital samples at a sample rate to a digital signal processor device (DSP) 1204. This may be a DSP chip, or a high performance microcomputer chip.

The digital signal processor device 1204 is programmed to provide a rectangular array of neural calculations, operating in real-time, having the structure shown in FIG. 8. Also provided is a parameter update device 1206, discussed below, which may be provided by the control circuit (microcomputer) of the mobile terminal 1200.

Thus, at each sample interval, a new digital sample is supplied from the radio circuit 1202 to the DSP 1204, where it is received at the inputs of all neurons of the first layer. In other words, in each sampling interval, the DSP performs the sequence of calculations required for each neuron of the first layer, to take the input and delayed versions of previous inputs, multiply them by the respective weight values, accumulate them, apply the non-linear function to them, and generate a corresponding neuron output. Then, within the sample interval, these neuron outputs thus calculated are used as inputs and the process is repeated for all the neurons of the next layer, and so on. Although the DSP inherently performs the calculations sequentially, the calculations nonetheless define a feed forward array of layers or neurons since the calculations corresponding to the neurons of each layer are performed before those of the layer which follows it.

In use, the DSP device decodes signals, and separates them into control signals and content signals. Content signals are supplied to applications (where they contain data—for example a web page) or a user interface (where they contain audio, video or images) 1208.

On receiving a control signal indicating a new parameter value set, the DSP device supplies it to the parameter update device 1206 which decodes the new parameter values set and stores it ready for use.

On receiving a control signal indicating that the new data processing technique is to be used, the parameter update device 1206 supplies the stored parameter value set to the digital signal processing device 1204, which uses the weight values and gating control word values to control the corresponding neurons during calculations, and supplies the timing waveforms to the timing controller 350 which gates the outputs of the different neuron calculations, so as to discard calculation for which the neuron concerned is in the off state.

Summary of Fourth Embodiment

It will be seen that the neurons of the above described embodiments are particularly suitable for providing a generic digital signal processing architecture for time varying signals, particularly in mobile communications platforms. The digital signal processor device within the mobile terminal is programmed to be able to perform neural calculations, and the nature of the coding is changed by transmitting the parameter value data used by the neural calculations (the weights, delay control words and timing control cycles). A broad range of digital signal processing functions can thus be executed, and easily changed by merely changing the parameter values (which is a low-bandwidth operation). It can be used, for example, to perform the digital parts of the “chain” of forward and reverse baseband modem processing, in particular channel coding and decoding.

The embodiments of the invention are not inherently better at learning to emulate function than neural networks of the prior art. Indeed, in the above embodiments it is necessary to manually supply control word values and timing control waveforms before training (based on some knowledge of the function to be trained), which would at first sight seem counterproductive in a neural network where the aim is usually to learn a function with no initial knowledge about it.

However, it is important to note that this approach reduces the training time required and, more importantly, the number of neurons and weight values required to emulate functions and therefore make it possible to download the neuron data in a shorter time.

Other Embodiments, Modification and Variants

It will be apparent from the foregoing embodiments that many other modifications, variants and embodiments are possible.

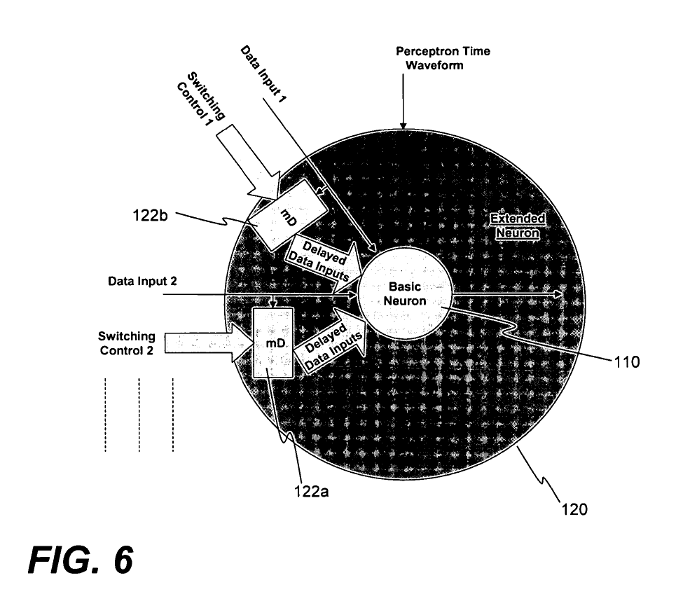

For example, although the above described embodiments use computers or digital signal processing devices to emulate a plurality of neuron units, in another embodiment of the invention, the network is implemented by a custom VLSI circuit comprising a rectangular array of neurons on a substrate, each neuron unit comprising the structures described in relation to FIG. 6. Each neuron may have a single CPU for performing the weight calculation, summation and non-linear transformation steps, but it is preferred to provide separate hardware for these operations, for higher processing speed. This embodiment is suitable for very high speed operation, since calculations of all neurons in a given layer are performed in parallel, so that the total processing time required to execute the neural network scales with the number of layers, rather than with the total number of neurons as in the embodiments described above.

In another embodiment, the neural network is implemented as a sampled analogue circuit, using analogue shift register devices (such as charge coupled devices (CCDs) or bucket brigade devices (BBDs)) as the serial to parallel converters, analogue multipliers and accumulators, and an analogue function generator for the non-linear function. Multiplying digital to analogue converters could be used as the weight multipliers, using the downloaded digital weight values to generate an analogue signal to an analogue input.

Many other variants are possible. For the avoidance of doubt, protection is hereby sought for any and all novel subject matter and combinations thereof.

1. A data processing device for processing time-varying signals, comprising:
input means for receiving a said time-varying signal;
computing means for performing a plurality of neuron computations, to provide at least two layers of said neuron computations each comprising at least two parallel said neuron computations, the outputs of one such layer being fed forward to another;
each said neuron computation comprising receiving a plurality of input signals, weighting each signal according to a predetermined weight value, and generating an output signal comprising a function of the weighted input signals; and
output means for generating at least one output signal from said computing means, the or each output signal comprising a function of the or each input signal; characterised by:
cyclical control signals associated with said neuron computations to indicate parts of a time cycle during which some of said neuron computations are inoperative; and
time control means for applying said cyclical control signals to said neuron computations during operation of said computing means on said time-varying signals.

2. A device according to claim 1, further comprising at least one serial to parallel convertor associated with each said neuron computation so as to provide a plurality of parallel inputs to the neuron computation comprising differently-delayed versions of the same signal.

3. A device according to claim 2, further comprising a gating arrangement associated with each said serial to parallel convertor, said gating arrangement being controllable by a predetermined and updatable control word to specify which of the parallel outputs of the convertor comprise said plurality of parallel inputs to the neuron computation.

4. A device according to claim 1, comprising a programmable signal processing device programmed to perform said plurality of neuron computations on a signal.

5. A device according to claim 1, including an integrated circuit comprising a plurality of neuron computation devices operating to perform said neuron computations in parallel.

6. A communications terminal device operable to communicate selectively over a communications channel in a plurality of different communications modes, comprising a data processing device for processing time-varying signals, said data processing device comprising:
input means for receiving a said time-varying signal;
computing means for performing a plurality of neuron computations, to provide at least two layers of said neuron computations each comprising at least two parallel said neuron computations, the outputs of one such layer being fed forward to another;
each said neuron computation comprising receiving a plurality of input signals, weighting each signal according to a predetermined weight value, and generating an output signal comprising a function of the weighted input signals; and output means for generating at least one output signal from said computing means, the or each output signal comprising a function of the or each input signal; and
a neuron updating circuit arranged to supply different parameter values for use in said neuron computations, so as to change the communications mode from one said predetermined mode to another.

7. A device according to claim 6, in which the data processing device is according to claim 1.

8. A device according to claim 6, operable to add a new communications mode by receiving new said parameter values via said communications channel.

9. A communications station for use in a system including a terminal according to claim 8, the station comprising means for transmitting a signal comprising new parameter values for neural computations, to add a new communications mode to said device.

10. A communications system comprising a plurality of terminals each having a neural network therein which has parameter values enabling the network to emulate a transmission processing stage in a transmission mode, and a transmission station for sending new parameter values to the terminals to change the operation of the neural networks to emulate a new transmission mode.

11. A method of operating a communications system comprising a plurality of terminals, each terminal including a feed-forward computation network operating in accordance with a plurality of network parameter values, comprising adding a new transmission mode by sending new network parameter values to the terminals.
